(19) United States
(12) Patent Application Publication
(10) Pub. No.: US 2014/0299585 A1
(43) Pub. Date: Oct. 9, 2014

(54) LASER CLADDING METHOD

(71) Applicant: Shandong Energy Machinery Group Han's Remanufacture Co., Ltd., Xintai, Shandong (CN)

(72) Inventors: Xiyong Li, Xintai (CN); Feng Zhou, Xintai (CN); Yanliang Zhang, Xintai (CN); Qingdong Yang, Xintai (CN); Lunchang Su, Xintai (CN); Chunchun Dong, Xintai (CN); Fanliang Tantai, Xintai (CN)

(21) Appl. No.: 14/356,709

(22) PCT Filed: Oct. 31, 2012
(86) PCT No.: PCT/CN2012/001475

§ 371 Date: May 7, 2014

(30) Foreign Application Priority Data
May 22, 2012 (CN) 201210159369.8

(51) Int. Cl. B23K 26/34; C23C 24/10

(52) U.S. Cl. CPC B23K 26/34; C23C 24/103
USPC 219/121.66

(57) ABSTRACT

In a laser cladding method, a laser beam is emitted from a semiconductor laser to melt alloy powder for laser cladding on the surface of a hydraulic support column. The semiconductor laser is a laser functioning with semiconductor material as gain medium and lighting by means of semiconductor material transition among energy bands. The hydraulic support column is mainly made of alloy steel of 27 SiMn. With the laser cladding method, the energy absorption efficiency of laser beam can be increased, and the energy utilization efficiency is increased, so that the power consumption is saved reduced.

### TECHNICAL FIELD

The present invention relates to a laser cladding method that belongs to the art of laser processing.

### BACKGROUND

Hydraulic support columns are key components in mining equipment. In China, hydraulic support columns are commonly surface treated using chromium plating, so as to prevent the surface from rusting and to prevent corrosion. However, the abrasion performance of the plated chromium layer is poor, and usually, there may be peeling and scaling of the plated chromium layer after 1 to 1.5 years. Therefore, the surface of the column may be corroded by emulsion, so that the usage of the hydraulic support may be affected.

A laser cladding method for a mining hydraulic support column is disclosed in Chinese Patent No. CN101875128B, by which three layers of metallurgy materials are clad under particular laser cladding process conditions, so that the problems about the abrasion performance and the anti-corrosion performance of the mining hydraulic support column surface are solved with the service life thereof increased. The detailed technical solution therein includes performing preheating after the mining hydraulic support column is surface treated, and then plating a bottom layer, a middle layer and a surface layer in sequence with alloy powder material for cladding. The chosen alloy powder material for cladding for the bottom layer includes 0.1% of C, 3.2% of Si, 0.5% of Mn, 10.2% of Cr, 8.8% of Ni, 0.8% of Nb, 0.1% of B, 0.5% of P and residual amount of Fe.

### BRIEF SUMMARY

In the abovementioned laser cladding method, the laser used is a carbon dioxide laser, i.e., a laser functioning with carbon dioxide as gain medium. However, when a carbon dioxide laser is being used to perform laser cladding, the laser beam coming out from the carbon dioxide laser irradiates the hydraulic support column, and energy absorption and utilization efficiency of laser beam is very low. Also, electric energy consumption in the process is relatively large.

In order to solve these technical problems, in the present invention, a laser cladding method is provided with which energy absorption and utilization efficiency of laser beam is increased, the electric energy utilization efficiency is increased, and power consumption is reduced.

The following are the technical solutions provided by the present invention.

Solution 1 is a laser cladding method that uses a laser beam emitted from a semiconductor laser to melt alloy powder for laser cladding on the surface of a hydraulic support column, so that a laser cladding layer is formed.

Solution 2 is the laser cladding method according to solution 1, changed in that the distance from a laser beam outlet of the semiconductor laser to the surface of the hydraulic support column is in the range of 150-250 mm, and the power density of the laser beam emitted from the semiconductor laser is above 109.38 W/mm².

Solution 3 is the laser cladding method according to solution 2, changed in that the distance from the laser beam outlet of the semiconductor laser to the surface of the hydraulic support column is in the range of 190-220 mm, and the power density of the laser beam emitted from the semiconductor laser is above 112.63 W/mm².

Solution 4 is the laser cladding method according to solution 3, changed in that the alloy powder for laser cladding is supplied at a speed of 38-40 g/min, and the diameter of the alloy powder for laser cladding is in the range of 44-178 μm. Further, the laser beam is a rectangular spot with a length of 16 mm and a width of 2 mm, and the linear scanning velocity of the laser beam is in the range of 540-780 mm/min, with the scanning direction of the laser beam perpendicular to the length direction of the rectangular spot.

Solution 5 is the laser cladding method according to solution 1, changed in that the alloy powder for laser cladding includes 0.01-0.15% of C, 0.5%-1.0% of Si, 0.4%-0.8% of Mn, 17.5%-19.5% of Cr, 21%-25% of Ni, and a residual amount of Fe and unavoidable impurities. The content of each element above is a content of weight percentage.

Solution 6 is the laser cladding method according to solution 1, changed in that the alloy powder for laser cladding includes 0.05%-0.20% of C, 1.0%-1.5% of Si, 0.4%-0.8% of Mn, 15.0%-15.8% of Cr, 4.0%-4.5% of Ni, and a residual amount of Fe and unavoidable impurities. The content of each element above is a content of weight percentage.

Solution 7 is the laser cladding method according to any one of solutions 1-6, changed in that the outer diameter of the hydraulic support column is in the range of 200-400 mm.

Solution 8 is the laser cladding method according to solution 7, changed in that the outer diameter of the hydraulic support column is in the range of 350-400 mm.

With the laser cladding method according to solution 1, the energy absorption and utilization efficiency of the laser beam is high, and because of high energy transition efficiency of the semiconductor laser, the electric energy utilization efficiency is increased with power consumption reduced.

In addition, in the solutions of the present invention, since a semiconductor laser is used, the continuous working time can be very long. For example, in an implementation process, the continuous working time can exceed 15000 hours. However, when a carbon dioxide laser is used, then the continuous working time is shorter because commonly a vacuum pumping operation needs to be performed once in every 24 hours.

With the laser cladding methods according to solutions 2-3, good process parameters are selected, i.e., the cooperative relationship between the distance from the laser beam outlet of the semiconductor laser to the surface of the hydraulic support column and the power density of the laser beam emitted from the semiconductor laser is optimized, so that laser cladding is performed effectively.

Solution 4 is a detailed embodiment, wherein many process parameters are defined, so that precise operating process parameters are provided to those skilled in the art.

With respect to the hydraulic support column obtained according to solution 5, because of the specific composition of the laser cladding layer, a good surface hardness, a long service life, a high bonding strength between the cladding layer and the metallic body, and a good salt spray resistance can be obtained. The hardness of the cladding layer on the surface of the hydraulic support column can exceed 30 HRC, the service life in mines is over 5 years, the bonding strength between the cladding layer and the metallic body can exceed 310 MPa, and the salt spray resistance can be maintained for over 96 hours.

With respect to the hydraulic support column obtained according to solution 6, on one aspect the hydraulic support column has all of the performance results of the hydraulic support column obtained according to solution 5. For example, the service life in mines is over 5 years, the bonding strength between the cladding layer and the metallic body can exceed 310 MPa, and the salt spray resistance can be maintained for over 96 hours. Moreover, the hardness of the cladding layer can exceed 45 HRC. Also, the cost is low because of the low content of Ni.

With the laser cladding method according to solutions 7 and 8, a preferable outer diameter of the hydraulic support column is given. Also, it is better for the outer diameter of the hydraulic support column to be larger. This is because that when the outer diameter of the hydraulic support column is larger, the outer surface of the column will be more close to a plane, and then the energy of the laser beam emitted from the semiconductor laser will be distributed more evenly on the surface of the hydraulic support column. But on the other hand, the outer diameter of the surface of the hydraulic support column should not be too large. This is because larger clamping means and larger carrying means are needed if the outer diameter of the hydraulic support column is too large. Therefore, the outer diameter of a preferable hydraulic support column is in the range of 200-400 mm, more preferably 350-400 mm. An even cladding could be achieved and loads for the other devices can be reduced when the outer diameter is within the above ranges.

### DETAILED DESCRIPTION

The solutions of the present invention will be described in detail with reference to the embodiments, so that the solutions of the present invention will be more apparent to those skilled in the art.

### First Embodiment

The embodiment is a laser cladding method for mining hydraulic support column.

The hydraulic support column used in the embodiment is a mining hydraulic support column used by XINJULONG ENERGY CO., LTD. of XINWEN MINING GROUP. The column is a hydraulic support column with a body of 27 SiMn and a diameter of 300 mm.

The laser cladding is performed with the following method.

1. Performing the process of rust removing and the process of texturing of the mining hydraulic support column.

2. Mounting the mining hydraulic support column into a laser process machine which is a semiconductor laser process machine, i.e., a laser process machine with a semiconductor laser.

3. Under the cooperation of the rotary motion of the main shaft and the feeding motion of the linear shaft of the laser head, powder feeding and laser cladding are carried out simultaneously in one process step. The output power of the semiconductor laser is 4000 W, the distance from the laser beam outlet of the semiconductor laser to the surface of the hydraulic support column is 200 mm, the linear scanning velocity of the laser beam is 540 mm/min, and the laser beam is a 16*2 rectangular spot (with a length of 16 mm and a width of 2 mm). The cladding is performed in a scanning cladding manner.

The adopted composition for laser cladding is in powder form with particle size in the range of 44-178 μm. The composition includes 0.05% of C, 1.5% of Si, 0.4% of Mn, 15.8% of Cr, 4.0% of Ni, and a residual amount of Fe and few unavoidable impurities. The alloy powder for laser cladding is fed at the powder feeding speed of 38-40 g/min.

4. Performing the machining.

In an embodiment, the total installed power of the semiconductor laser is 45 KW (kilowatt), the continuous power output of the semiconductor laser is 4000 W, the absorption efficiency of metallic material (i.e., the absorption efficiency of the column) is 80%, the dimensions of the semiconductor laser are 260 mm×118 mm×450 mm, the weight of the semiconductor laser is 27 kg, and the continuous working time can achieve 15000 hours.

In an embodiment, the heat absorbed by the metallic material is 3200 KW.

The following are performance indices tested in the experiments and tests to the obtained column.

1. No cracks.

2. The hardness of the cladding layer can exceed 45 HRC, the service life in mines is over 5 years, the bonding strength between the cladding layer and the column body can exceed 310 MPa, and the salt spray resistance can be maintained for over 96 hours.

With regard to the service life, the column has been promoted and used in XINJULONG ENERGY CO., LTD. of XINWEN MINING GROUP with good effects. The column has been used at the mining face for four years without any quality problem.

With regard to the experiment of salt spray resistance, China National Standard GB/T10125-1997 is adopted, and the reagent used in the experiment is aqueous solution of sodium chloride with a concentration of 50g/L±5g/L, a PH value of 6.5-7.2, and a temperature of 35° C.±2° C.

The cost is low because of the low content of Ni in the embodiment.

### Second Embodiment

The embodiment is a laser cladding method for a mining hydraulic support column.

The hydraulic support column used in the embodiment is a mining hydraulic support column used by XINJULONG ENERGY CO., LTD. of XINWEN MINING GROUP. The column is a hydraulic support column with a body of 27 SiMn and a diameter of 400 mm.

The laser cladding is performed with the following method.

1. Performing the process of rust removing and the process of texturing of the mining hydraulic support column.

2. Mounting the mining hydraulic support column into a laser process machine which is a semiconductor laser process machine.

3. Under the cooperation of the rotary motion of the main shaft and the feeding motion of the linear shaft of the laser head, powder feeding and laser cladding are carried out simultaneously in one process step. The output power of the semiconductor laser is 4000 W, the distance from the laser beam outlet of the semiconductor laser to the surface of the hydraulic support column is 250 mm, the linear scanning velocity of the laser beam is 600 mm/min, and the laser beam is a 16*2 rectangular spot (with a length of 16 mm and a width of 2 mm). The cladding is performed in a scanning cladding manner.

The adopted composition for laser cladding is in powder form with particle size in the range of 44-178 μm. The composition includes 0.15% of C, 1.0% of Si, 0.8% of Mn, 15.0% of Cr, 4.5% of Ni, and a residual amount of Fe and unavoidable impurities. The alloy powder for laser cladding is fed at the powder feeding speed of 38-40 g/min.

4. Performing the machining.

It should be noted that in the embodiment, the total installed power of the semiconductor laser is 45 KW (kilowatt), the continuous power output of the semiconductor laser is 4000 W, the absorption efficiency of metallic material is 80%, the dimensions of the semiconductor laser are 260 mm×118 mm×450 mm, the weight of the semiconductor laser is 27 kg, and the continuous working time can achieve 15000 hours.

The following are performance indices tested in the experiments and tests to the obtained column.

1. No cracks.

2. The hardness of the cladding layer can exceed 45 HRC, the service life in mines is over 5 years, the bonding strength between the cladding layer and the column body can exceed 310 MPa, and the salt spray resistance can be maintained for over 96 hours.

### Third Embodiment

The embodiment is a laser cladding method for a mining hydraulic support column.

The hydraulic support column used in the embodiment is a mining hydraulic support column used by XINJULONG ENERGY CO., LTD. of XINWEN MINING GROUP. The column is a hydraulic support column with a body of 27 SiMn and a diameter of 300 mm.

The laser cladding is performed with the following method.

1. Performing the process of rust removing and the process of texturing of the mining hydraulic support column.

2. Mounting the mining hydraulic support column into a laser process machine which is a semiconductor laser process machine.

3. Under the cooperation of the rotary motion of the main shaft and the feeding motion of the linear shaft of the laser head, powder feeding and laser cladding are carried out simultaneously in one process step. The output power of the semiconductor laser is 4000 W, the distance from the laser beam outlet of the semiconductor laser to the surface of the hydraulic support column is 250 mm, the linear scanning velocity of the laser beam is 600 mm/min, and the laser beam is a 16*2 rectangular spot (with a length of 16 mm and a width of 2 mm). The cladding is performed in a scanning cladding manner.

The adopted composition for laser cladding is in powder form with particle size in the range of 44-178 μtm. The composition includes 0.15% of C, 1.0% of Si, 0.8% of Mn, 18.0% of Cr, 22.0% of Ni, and a residual amount of Fe and unavoidable impurities. The alloy powder for laser cladding is fed at the powder feeding speed of 38-40 g/min.

4. Performing the machining.

It should be noted that in this embodiment, the total installed power of the semiconductor laser is 45 KW, the continuous power output of the semiconductor laser is 4000 W, the absorption efficiency of metallic material is 80%, the dimensions of the semiconductor laser are 260 mm×118 mm×450 mm, the weight of the semiconductor laser is 27 kg, and the continuous working time can achieve 15000 hours.

The following are performance indices tested in the experiments and tests to the obtained column.

1. No cracks.

2. The hardness of the cladding layer can exceed 30 HRC, the service life in mines is over 5 years, the bonding strength between the cladding layer and the column body can exceed 310 MPa, and the salt spray resistance can be maintained for over 96 hours.

### Embodiment for Comparison

The embodiment is a laser cladding method for mining hydraulic support column.

The hydraulic support column used in the embodiment is a mining hydraulic support column used by XINJULONG ENERGY CO., LTD. of XINWEN MINING GROUP. The column is a hydraulic support column with a body of 27 SiMn and a diameter of 300 mm.

The laser cladding is performed with the following method.

1. Performing the process of rust removing and the process of texturing of the mining hydraulic support column.

2. Mounting the mining hydraulic support column into a laser process machine which is a carbon dioxide laser process machine, i.e., a laser process machine with a carbon dioxide laser.

3. Under the cooperation of the rotary motion of the main shaft and the feeding motion of the linear shaft of the laser head, powder feeding and laser cladding are performed in synchronization in one process step. The output power of the carbon dioxide laser is 8000 W, the distance from the laser beam outlet of the laser to the surface of the hydraulic support column is 300 mm, the linear scanning velocity of laser is 480 mm/min, and the laser beam is a 15*2.5 rectangular spot (with a length of 15 mm and a width of 2.5 mm). The cladding is performed in a scanning cladding manner.

The adopted composition for laser cladding is in powder form with particle size in the range of 44-178 μm. The composition includes 0.02% of C, 1.5% of Si, 0.4% of Mn, 15.8% of Cr, 4.0% of Ni, and a residual amount of Fe and unavoidable impurities. The alloy powder for laser cladding is fed at the powder feeding speed of 38-40 g/min.

4. Performing the machining.

It should be noted that said carbon dioxide laser is a laser functioning with carbon dioxide as gain medium and lighting by means of transition of the carbon dioxide among energy bands. In this embodiment, the total installed power of the carbon dioxide laser is 175 KW, the continuous power output of the carbon dioxide laser is 8000 W, the absorption efficiency of metallic material (i.e., the absorption efficiency of the column) is 40%, the dimensions of the carbon dioxide laser are 2500 mm×1500 mm×2300 mm, the weight of the carbon dioxide laser is 4000 kg, and the continuous working time is 24 hours because a vacuum pumping process needs to be performed once in every 24 hours for such laser.

In this embodiment, the heat absorbed by the metallic material is 3200 KW.

It can be seen that the carbon dioxide laser is large in size and inconvenient to operate. In addition, the continuous power output of the carbon dioxide laser cannot be lowered to 4000 W, so that power consumption cannot be decreased significantly.

The following are performance indices tested in the experiments and tests to the obtained column.

1. No cracks.

2. The hardness of the cladding layer can exceed 45 HRC, the service life in mines is over 5 years, the bonding strength between the cladding layer and the column body can exceed 310 MPa, and the salt spray resistance can be maintained for over 96 hours.

1. A laser cladding method, comprising:
using a laser beam emitted from a semiconductor laser to melt alloy powder for laser cladding on a surface of a hydraulic support column; wherein
the semiconductor laser is a laser functioning with semiconductor material as a gain medium and lighting by means of transition of the semiconductor material among energy bands.

2. The laser cladding method according to claim 1 wherein a distance from a laser beam outlet of the semiconductor laser to the surface of the hydraulic support column is in the range of 150-250 mm, and a power density of the laser beam emitted from the semiconductor laser is above 109.38 W/mm².

3. The laser cladding method according to claim 2 wherein the distance from the laser beam outlet of the semiconductor laser to the surface of the hydraulic support column is in the range of 190-220 mm, and the power density of the laser beam emitted from the semiconductor laser is above 112.63 W/mm².

4. The laser cladding method according to claim 3, further comprising:
supplying the alloy powder for laser cladding at a speed of 38-40 g/min; wherein
a diameter of the alloy powder for laser cladding is in the range of 44-178 μm;
the laser beam is a rectangular spot with a length of 16 mm and a width of 2 mm;
a linear scanning velocity of the laser beam is in the range of 540-780 mm/min; and
a scanning direction of the laser beam is perpendicular to the length direction of the rectangular spot.

5. The laser cladding method according to claim 1 wherein the alloy powder for laser cladding includes:
0.01%-0.15% of C,
0.5%-1.0% of Si,
0.4%-0.8% of Mn,
17.5%-19.5% of Cr,
21%-25% of Ni, and
a residual amount of Fe and unavoidable impurities;
wherein the content of each element above is a content of weight percentage.

6. The laser cladding method according to claim 1 wherein the alloy powder for laser cladding includes:
0.05%-0.20% of C,
1.0%-1.5% of Si,
0.4%-0.8% of Mn,
15.0%-15.8% of Cr,
4.0%-4.5% of Ni, and
a residual amount of Fe and unavoidable impurities;
wherein the content of each element above is a content of weight percentage.

7. The laser cladding method according to claim 1 wherein an outer diameter of the hydraulic support column is in the range of 200-400 mm.

8. The laser cladding method according to claim 7 wherein the outer diameter of the hydraulic support column is in the range of 350-400 mm.
